(19) United States
(12) Patent Application Publication
(10) Pub. No.: US 2024/0151101 A1
(43) Pub. Date: May 9, 2024

(54) ROMAN BLIND WITH SHROUD PROTECTION

(71) Applicant: MAXXMAR INC, Toronto (CA)

(72) Inventors: Mario Marocco, Toronto (CA); Steven Marocco, Toronto (CA)

(21) Appl. No.: 17/983,211

(22) Filed: Nov. 8, 2022

(51) Int. Cl. E06B 9/262

(52) U.S. Cl. CPC E06B 9/262; E06B 2009/2622

(57) ABSTRACT

A window covering comprising: a fabric having a top and bottom for covering a window; a plurality of horizontally spaced members attached to said fabric between said top and bottom; at least one attachment secured to each said spaced member; a flexible sleeve attached to each said attachment of said plurality of horizontally spaced members between said top and bottom of said fabric; and a cord extending inside said flexible sleeve from said bottom to said top for lifting said fabric from a closed position covering said window to an open position revealing said window.

### FIELD OF INVENTION

This invention relates to child safety lift cord systems for window blinds and shades, and in particular relates to Roman blind window coverings having a plurality of spaced horizontal ribs attached to said window covering at vertically spaced intervals with guides attached to said plurality of ribs, and a flexible sleeve or shroud running through said guides with a cord running through said flexible sleeve or shroud for raising and lowering said window covering. The invention also relates to a reciprocating wand having an extension to accommodate high windows.

### BACKGROUND OF THE INVENTION

A roman blind or shade is a window blind consisting of a length of material which, when drawn up, gathers into horizontal folds from the bottom. Roman shades are simply fabric window coverings that can be raised or lowered with the help of a cord system and rings sewn on the back of the fabric. When raised, the fabric stacks evenly in horizontal folds.

Roman blinds can be flat roman or hobbled roman blinds. Flat Roman Shades are made of a continuous piece of fabric and hang flat against the window and are made of horizontal fabric panels backed with sturdy bars to strengthen the shade. This style is more rigid and offers a structured look. Hobbled fold roman shades have excess fabric between each pleat which gathers when the roman shades are closed. A flat fold roman shade is made with the exact length of fabric so when the shades are closed the fabric lays flat.

There has been a movement to design and manufacture window blinds and shades that are safe to operate and minimize the chance of a child getting tangled in the cords that raise and lower the window blinds and shades. One such strategy involves the use of shrouds or cord coverings.

For example U.S. Pat. No. 8,316,911 illustrates a lift cord safety system for use with a Roman shade type window covering having a head rail, a bottom rail and a shade movable between a raised and a lowered position. At least one lift cord vertically extends down from the head rail toward the bottom rail. A flexible sleeve is associated with and substantially surrounds each lift cord. A set of vertically spaced guides are also associated with each lift cord and are attached to the shade. The sleeve and the lift cord are disposed within each guide of the associated set of vertically spaced guides. A zip tie affixes the sleeve to each guide of the associated set of vertically spaced guides.

U.S. Pat. No. 8,381,792 shows a safety device for a window covering comprises a head rail and a shade panel extending from the head rail. A lift cord extends along one side of the shade panel between the head rail and the bottom of the shade panel. A safety device engages the lift cord to control the movement of the lift cord away from the shade panel. The safety device may also shroud the lift cord to limit access to the lift cord portion

There are other patents showing blinds with a shroud surrounding lift cords such as U.S. Pat. Nos. 9,493,981 and 8,365,795.

It is an object of this invention to provide and improved Roman Blind with a flexible sleeve or shroud that is easy to manufacture and operate.

### SUMMARY OF THE INVENTION

It is an aspect of the invention to provide a window covering comprising: a fabric having a top and bottom for covering a window; a plurality of horizontally spaced members attached to said fabric, between said top and bottom; at least one attachment secured to each said spaced member; a flexible sleeve attached to each said attachment of said plurality of horizontally spaced members between said top and bottom of said fabric; and a cord extending inside said flexible sleeve from said bottom to said top for lifting said fabric from a closed position covering said window to an open position revealing said window.

In one embodiment the flexible sleeve includes a grommet adjacent said top attached to said fabric and including an opening in said flexible sleeve for said cord to extend through and into said grommet.

In another embodiment the top of said fabric depends from a head rail. In another embodiment the head rail includes a rotating member attached to said cord that extends through said grommet so as to lift said fabric to said open position when said rotating member is rotated in a first direction and to close said window in said closed position when said rotating bar is rotated in a second direction.

In another embodiment a wand is attached to said head rail to rotate said rotating member in a first and second direction. The wand can comprise two intersecting recesses or projections coaxially disposed within a hand pumping sleeve for rotating said rotatable member between a first and second direction and raise and lower said fabric between an open and closed position when said hand pumping sleeve is moved between a first hand pumping position and a second hand pumping position.

In another embodiment the horizontally spaced members comprise ribs that include a first channel extending along the length of said ribs to receive a horizontal portion of said fabric. The first channel is “C”-shaped in cross section” and includes a rod that extends through said first channel to trap said horizontal portion of said fabric between said rod and said first channel.

In a further embodiment the attachment comprises a “D-shaped” loop, and said ribs include a second channel extending along the length of said rib for slidingly receiving said “D-shaped loops, and said flexible sleeve extends within the space formed by said “D-shaped loops” and are attached to said “D-shaped loops by tie clips. The window covering can comprise a Roman blind.

In another embodiment the spaced loops include a base and wherein said D-shaped loops are in line with said base.

Another aspect of this invention relates to a roman blind for a window comprising: a head rail having a rotatable member therein; fabric having a top and bottom for covering a window; said fabric depending from said head rail for covering said window; a plurality of horizontally spaced ribs extending across said fabric, said plurality of horizontally spaced ribs including a first recess for receiving and attaching a horizontal portion of said fabric to said plurality of said horizontally spaced ribs, between said top and bottom of said fabric; a first and second spaced loops secured to each said plurality of horizontally spaced ribs; first and second spaced flexible sleeves disposed vertically through said first and second spaced loops respectively; a plurality of attachments extending through each said first and second flexible sleeves for attaching said sleeves to said loops respectively; first and second cords extending inside said first and second flexible sleeves respectively from said bottom to said bottom, wherein a top of each said cord is attached to said rotatable member; and a wand depending from said head rail for rotating said rotatable member in a first direction for winding said spaced first and second cords around said rotatable member and moving said first and second spaced cords within said first and second flexible sleeves respectively so as to move said fabric from a closed position to an open position, and for rotating said rotatable member in a second direction for unwinding said first and second cords from said rotatable member and moving said spaced first and second cords within said first and second flexible sleeves respectively so as to move said fabric from an open position to an closed position.

In one embodiment the plurality of ribs includes a second channel, and said loops include an attachment portion slidingly receivable within said second recess for placement along said rib.

In another embodiment the attachment comprises a tie clip extending through said flexible sleeve at each said loop.

It is another aspect of this invention to provide a head rail for a roman blind having a top, front and rear panel with an open bottom and a partition wall extending from said front panel and disposed between said top panel and said open bottom to define a first chamber having a rotatable member therein, said front panel and partition wall blocking access to said cords.

It is a further aspect of this invention to provide a wand for a window blind said wand comprising: a shaft having two intersecting recesses or projections coaxially disposed within a hand pumping sleeve for rotating said rotatable member between a first and second direction and raise and lower said window blind between an open and closed position when said hand pumping sleeve is moved between a first hand pumping position and a second hand pumping position.

These and other features and objects of the invention will now be described in relation to the following drawings.

### SUMMARY OF DRAWING

FIG. 1 is a front perspective view of a Roman blind with a head rail in a closed position and one example of a lift wand

FIG. 2 is a rear perspective view of FIG. 1 in a closed position.

FIG. 3 is a left side elevational view of FIG. 1.

FIG. 4 is a front elevational view of FIG. 1 in a closed position.

FIG. 5 is a right side elevational view of FIG. 1.

FIG. 6 is a rear elevational view of FIG. 2 in a closed position.

FIG. 7A is a cross sectional view of FIG. 3 in a lowered position.

FIG. 7B is a cross sectional view of FIG. 3 in a partially open position.

FIG. 7C is a cross sectional view of FIG. 3 in a fully open position.

FIG. 8A is a partial rear view of FIG. 6 showing the cord freely moveable within a flexible sleeve, the flexible sleeve attached to a rib by for example a tie clip.

FIG. 8B is a cross sectional view taken along the line 8B-8B of FIG. 8A.

FIG. 9 is a front perspective view of a Roman blind with a head rail in a open position and one example of a lift wand.

FIG. 10 is a rear perspective view of FIG. 2 in an open position.

FIG. 11 is a front elevational view of FIG. 1 in a closed position

FIG. 12 is a rear elevational view of FIG. 2 in an open position.

FIG. 13 is a rear elevational view of a Roman blind with a reciprocating wand to lift and lower the roman blind.

FIGS. 14A and 14B, are perspective views, of another embodiment of the invention showing that the loops have a base that may stick out from the channel.

These and other features of the invention shall now be described.

### DETAILED DESCRIPTION OF THE INVENTION

Like parts are described with like numbers throughout the drawings.

The Figures generally illustrate a roman blind 2 having ahead rail 4, fabric covering 6 with a top 8 and bottom 10. The roman blind 2 also includes a plurality of horizontally spaced members 12 attached to said fabric, between said top 8 and bottom 10 and at least one attachment 20 secured to each said spaced member 12. The roman blind includes a flexible sleeve 30 attached to each said attachment 20 of said plurality of horizontally spaced members 12 between said top 8 and bottom 10 of said fabric covering 6.

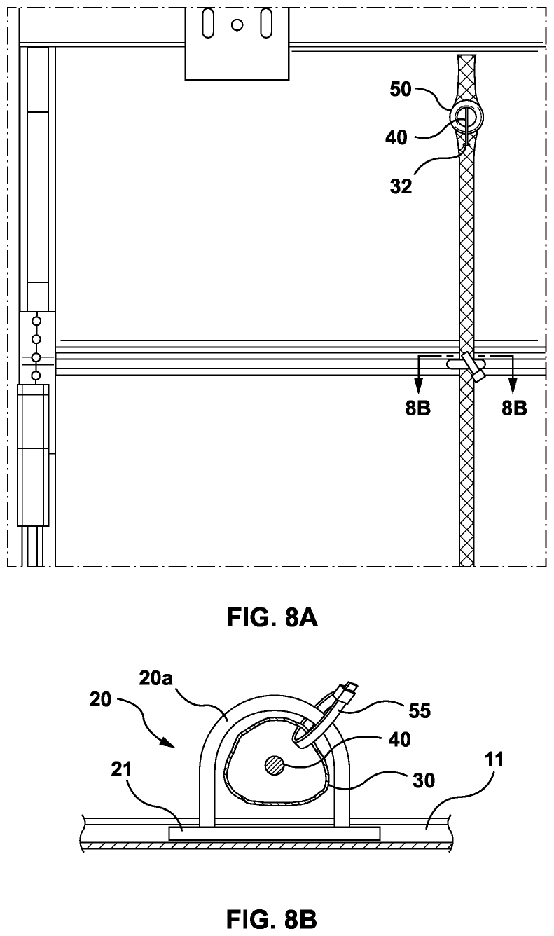

As best seen in FIGS. 8A and 8B there is a cord 40 extending inside said flexible sleeve 30 from said bottom 10 to said top 8 for lifting said fabric covering 6 from a closed position covering said window to an open position revealing said window (not shown).

In one embodiment the roman blind 2 includes a grommet 50 adjacent said top attached to said fabric and including an opening 32 in said flexible sleeve for said cord 40 to extend through and into said grommet 50.

The top 8 top of said fabric covering 6 depends from the head rail 4 as described below.

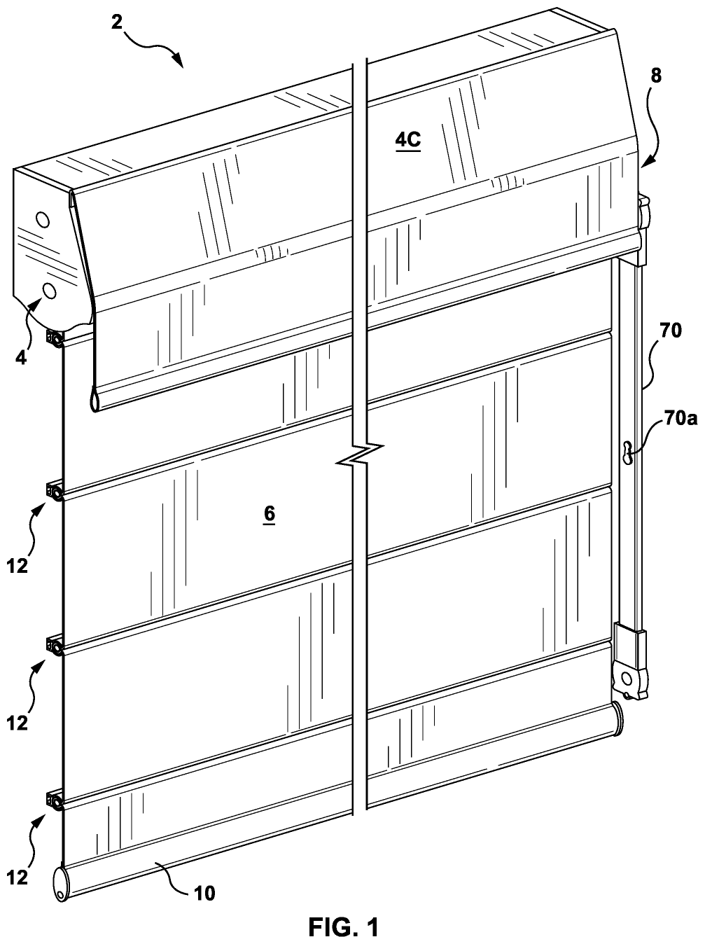

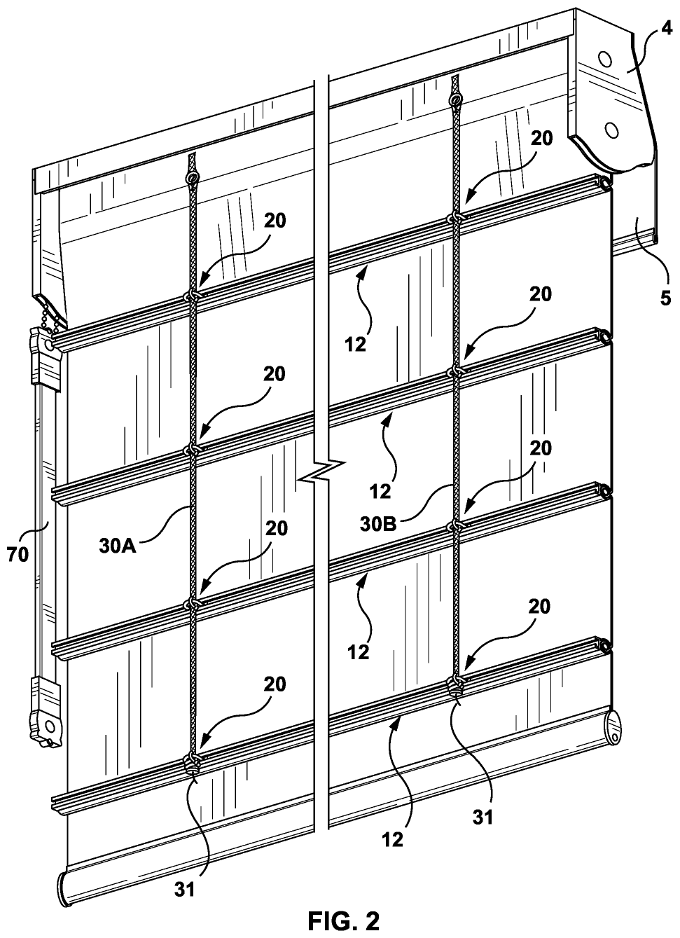

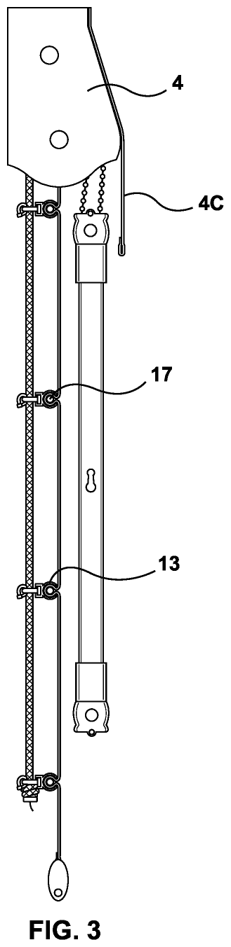

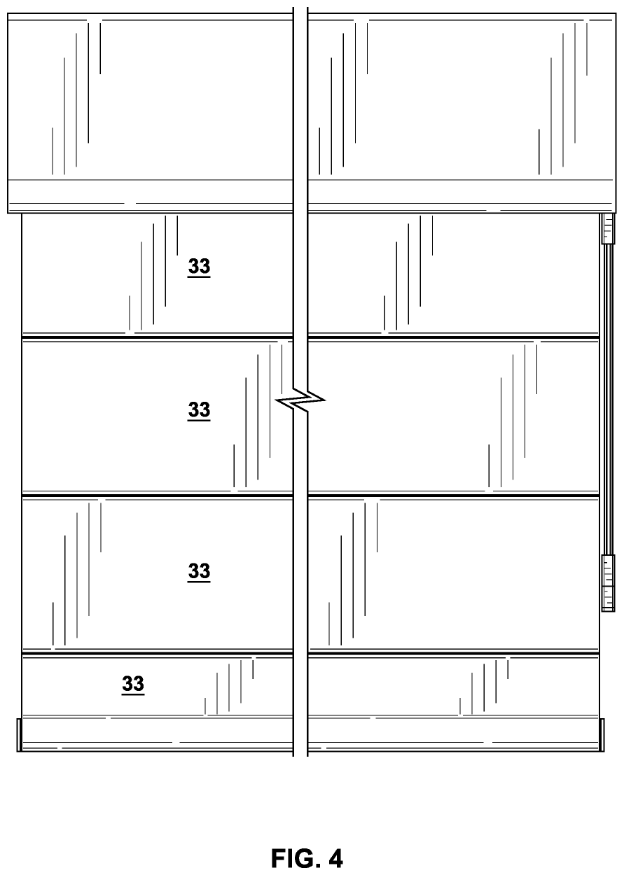

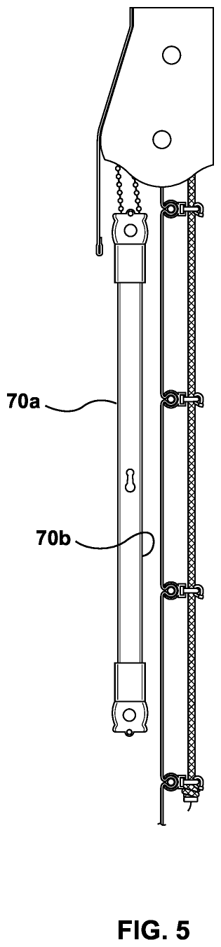

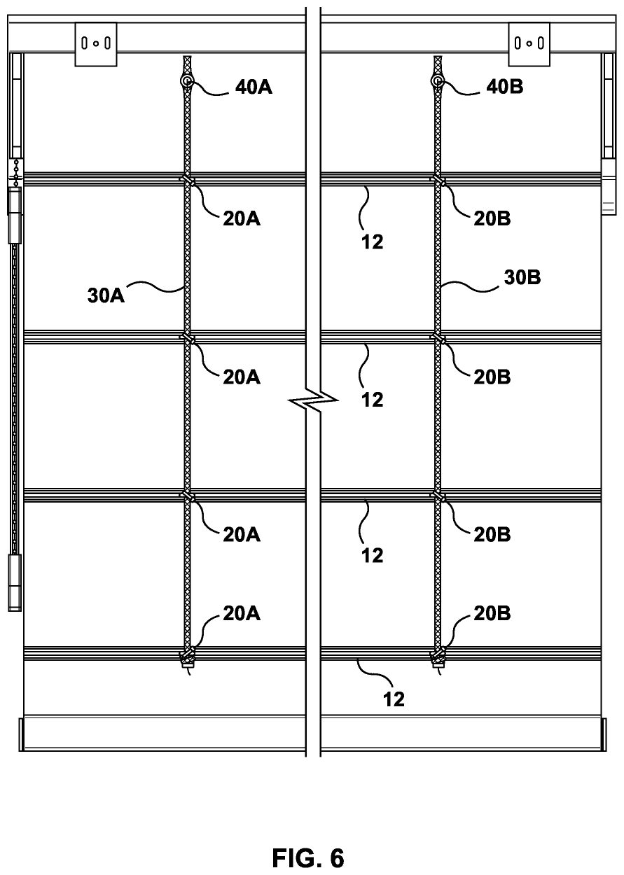

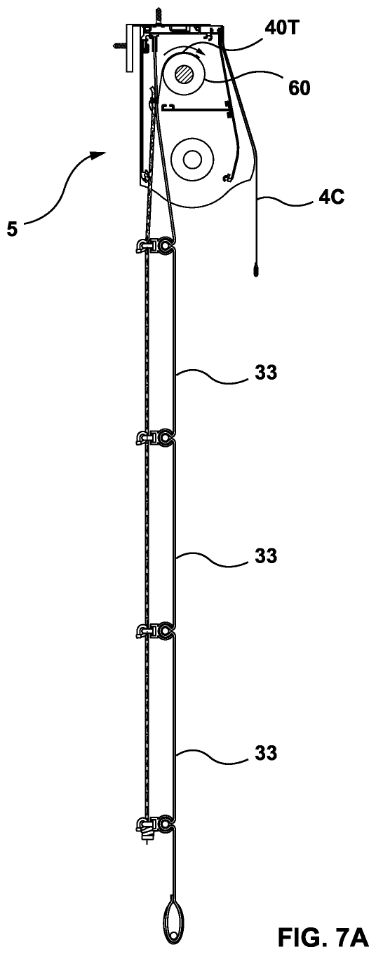

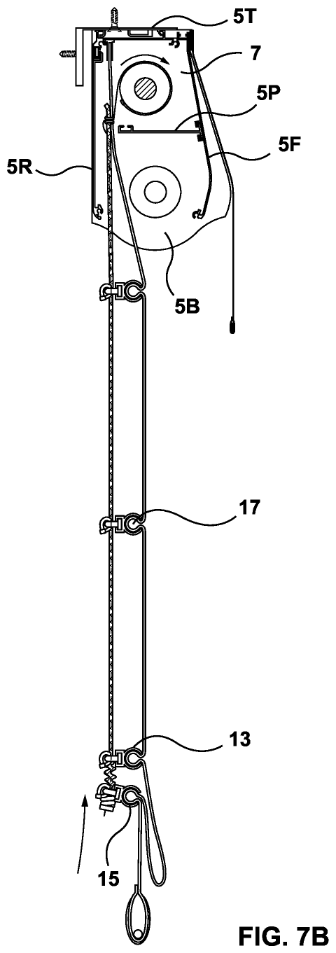

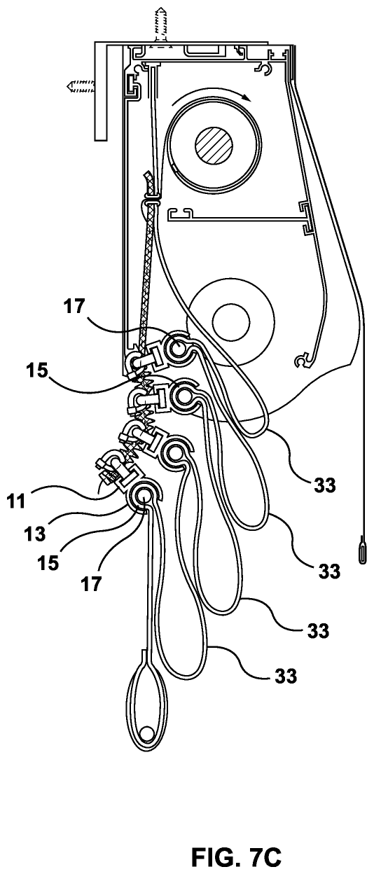

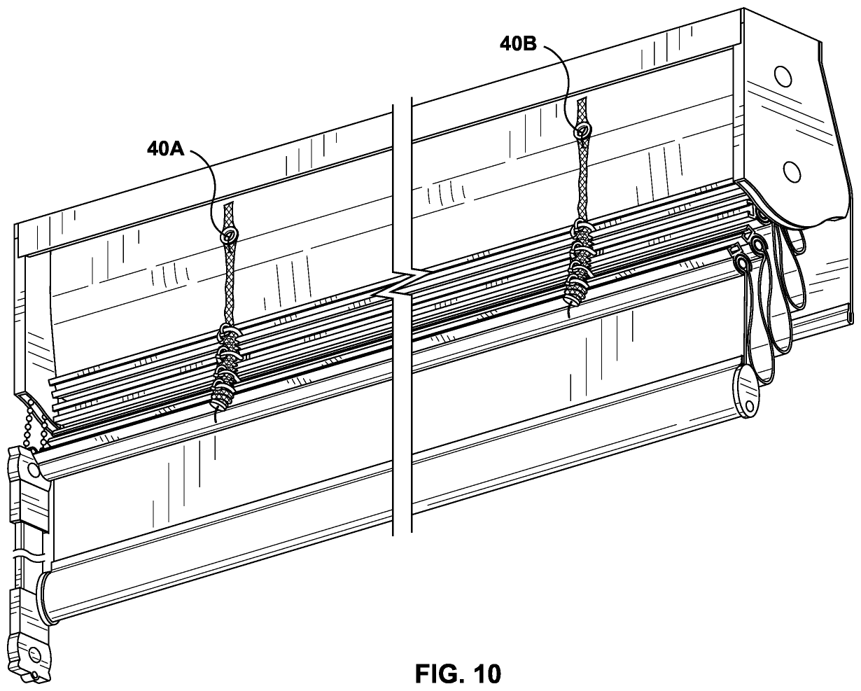

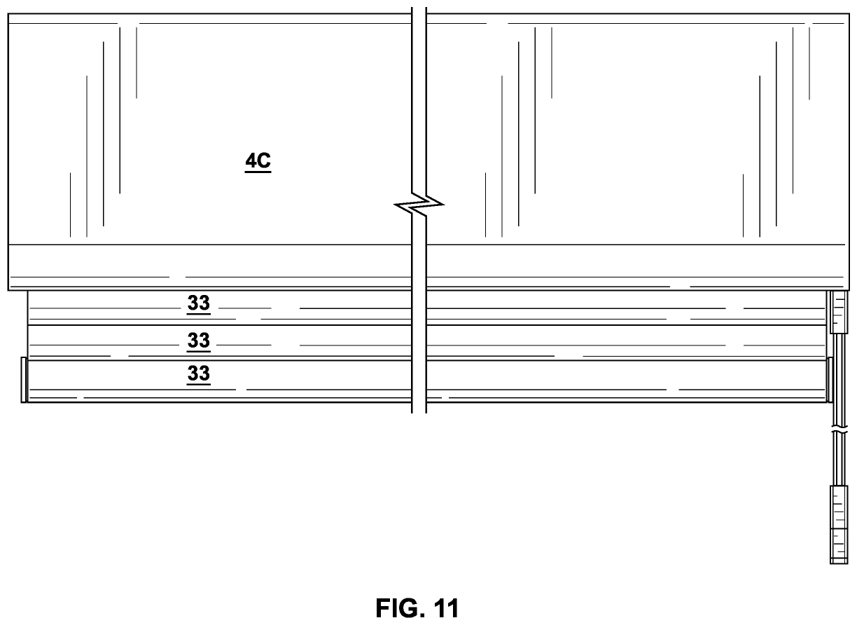

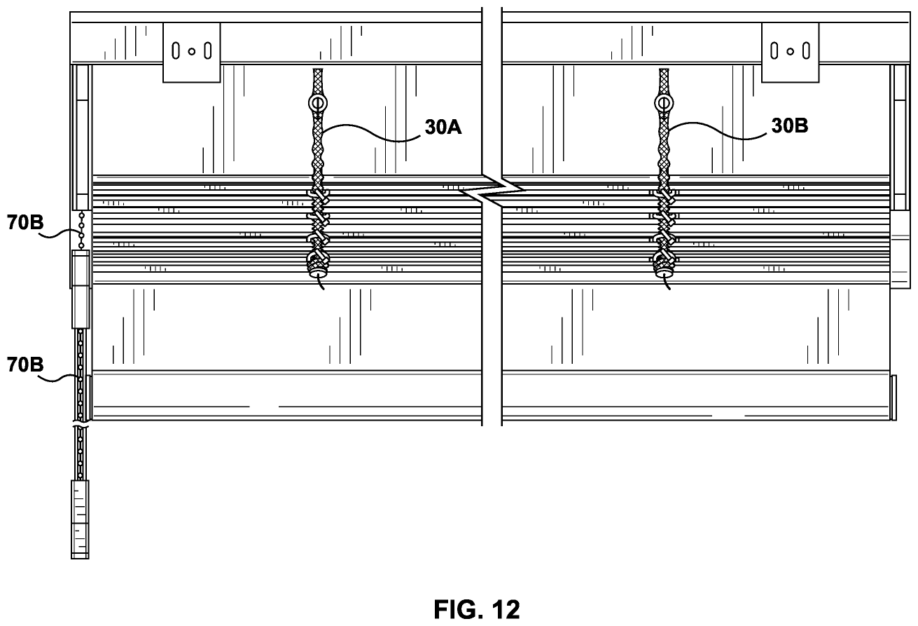

The head rail 4 includes a rotating member 60 attached to said cord 40 that extends through said grommet 50 so as to lift said fabric covering 6 to said open position shown in FIGS. 7C and 10 when said rotating member 60 is rotated in a first direction and to close said roman blind 2 in said closed position when said rotating member is rotated in a second direction as shown in FIGS. 1, 3, and 7A.

A wand 70 is operable with the rotating member 60 in the head rail 4 to rotate said rotating member 60 in a first and second direction.

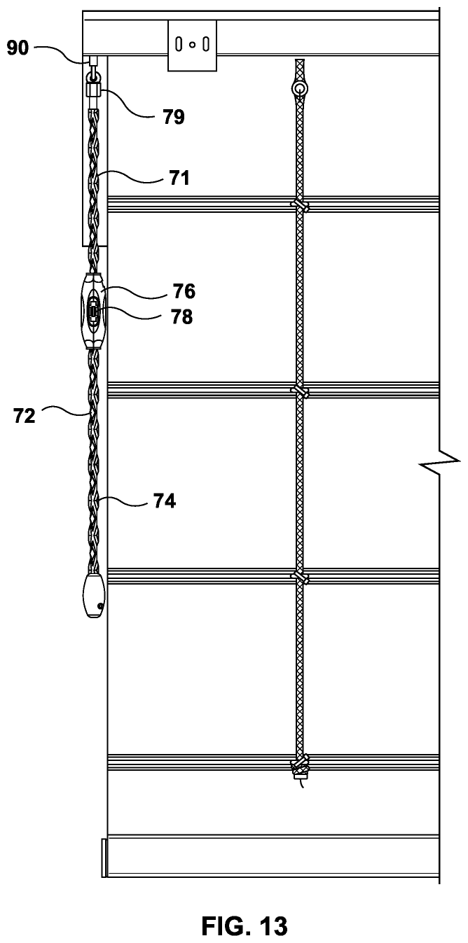

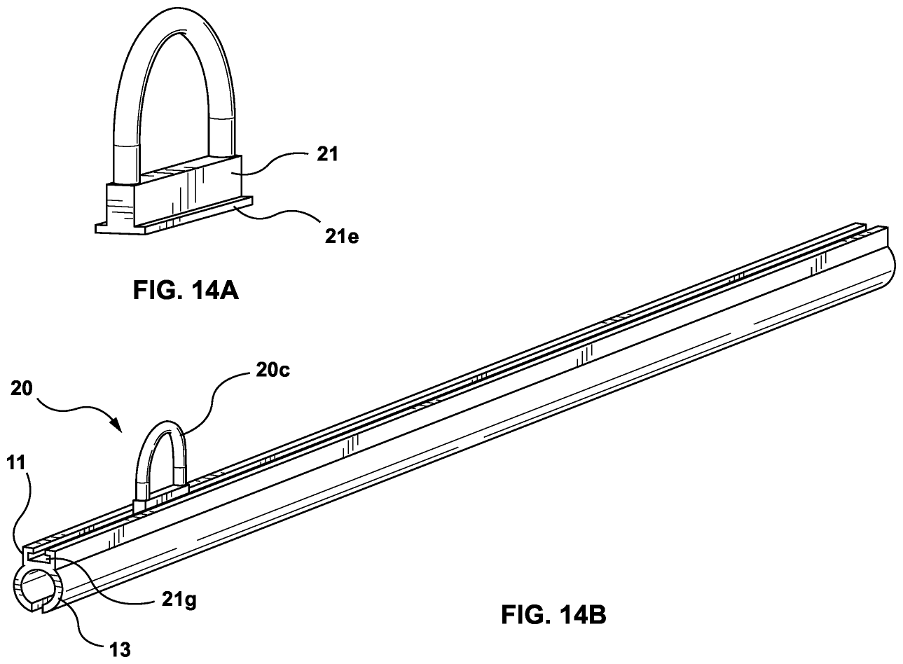

In one embodiment the wand 70 has a shaft 71 presenting two intersecting recesses 72 or projections 74 coaxially disposed within a hand pumping sleeve 76 for rotating said rotatable member between a first and second direction and raise and lower said fabric covering 6 between an open and closed position when said hand pumping sleeve 76 is moved or reciprocated between a first hand pumping position and a second hand pumping position. The hand pumping sleeve 76 has a switch 78 to rotate the shaft 71 in a first direction or a second direction. As shown in FIG. 13 one end 79 of said wand 70, 71 has a connecting piece 79 such as a hook or opposing fingers to connect to an operating extension 90 in the head rail 4 operably connected to the rotating member 60. The wand 70, the shaft 71 can comprise of suitable material such as plastic, so that the shaft 71 and recesses or protrusions 72, and 74 respectively can be relatively easily manufactured by extrusion means, for example.

Another embodiment of the wand 70 is shown in FIGS. 1,2 and 6 which includes a wand 70 having opposite wand channels 70a and 70b for receiving an endless loop of spaced beads 70b that can be access by moving cam lever 70c to expose the spaced beads for movement so as to rotate the rotatable member 60. Once moved the beads can be released which spring back to the wand channels 70a and 70b.

In one embodiment the horizontally spaced members 12 comprise ribs that include a first channel 13 extending along the length of said ribs 12 to receive a horizontal portion 15 of said fabric covering 6. In one embodiment the first channel 13 is “C”-shaped in cross section” as seen in FIG. 7C and including a rod 17 that extends through said first channel 13 to trap said horizontal portion 15 of said fabric covering 6 between said rod 17 and said first channel 13.

In one embodiment the attachment 20 comprises a “D-shaped” loop 20a, and said ribs 12 include a second channel 11 extending along the length of said rib 12 for slidingly receiving said “D-shaped loops 20a, and said flexible sleeve 30 extends within the space formed by said “D-shaped loops” and are attached to said “D-shaped loops by tie clips 55.

The Figures illustrate a roman blind 2 for a window (not shown) comprising:
a) a head rail 4 having a rotatable member 60 therein;
b) fabric covering 6 having a top 8 and bottom 10 for covering a window; said fabric covering 6 depending from said head rail 4 for covering said window;
c) a plurality of horizontally spaced ribs 12 extending across said fabric covering 6, said plurality of horizontally spaced ribs 12 including a first channel or 13 recess for receiving and attaching a horizontal portion of said fabric 15 to said plurality of said horizontally spaced ribs 12, between said top 8 and bottom 10 of said fabric covering 6;
d) first and second spaced loops 20A and 20B respectively secured to each said plurality of horizontally spaced ribs 12;
e) first and second spaced flexible sleeves 30A and 30B respectively disposed vertically through said first and second spaced loops 20A and 20B respectively;
f) a plurality of attachments 55 extending through each said first and second flexible sleeves 30A and 30B for attaching said flexible sleeves or shrouds 30A and 30B to said loops 20A and 20B respectively;
g) first and second cords 40A and 40B extending inside said first and second flexible sleeves 30A and 30B respectively from said bottom 10 to said top 8, wherein a top 40T of each said cord 40A and 40B is attached to said rotatable member 60 as shown in FIG. 7A; and
h) a wand 70 depending from said head rail 4 for rotating said rotatable member 60 in a first direction for winding said spaced first and second cords 40A and 40B around said rotatable member 60 and moving said first and second spaced cords 40A and 40B within said first and second flexible sleeves 30a and 30B respectively so as to move said fabric covering 6 from a closed position as shown in FIGS. 1,2 and 3 to an open position as shown in FIGS. 7C, and for rotating said rotatable member 60 in a second direction for unwinding said first and second cords from said rotatable member 60 and moving said spaced first and second cords 40A and 40B within said first and second flexible sleeves 30A and 30B respectively so as to move said fabric covering 6 from an open position to an closed position.

The plurality of ribs 12 includes a second channel 11, and said loops 20 include an attachment portion 21 slidingly receivable within said second recess 11 for sliding placement along said rib 12. Since the attachment portion 21 is slideable within the second channel or recess lithe loops 20 are self adjustable or alignable vertically as they are connected to the flexible sleeves 30A and 30B respectively In one embodiment comprises a tie clip 55 extending through said flexible sleeve 30 at each said loop 20.

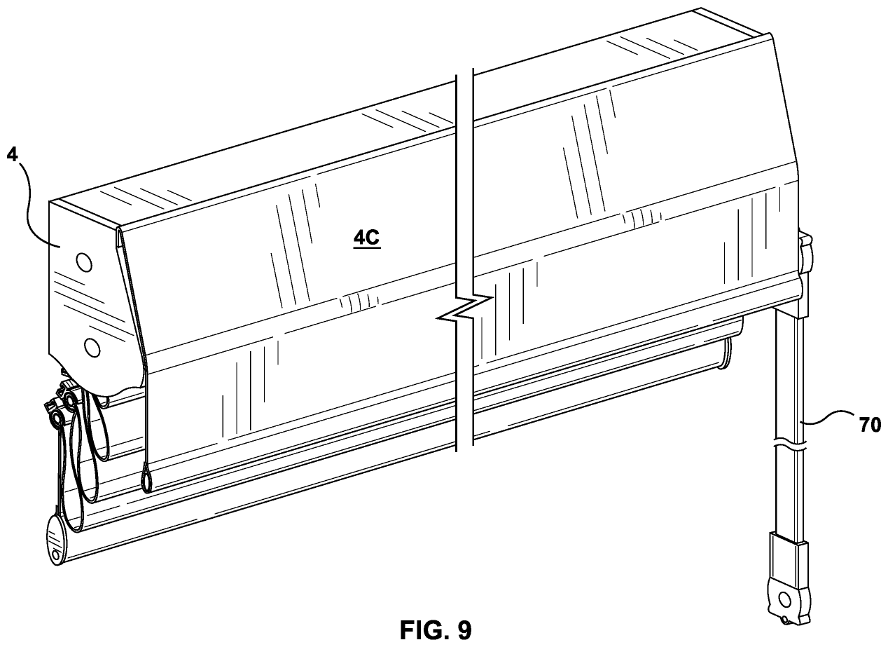

The bottom 31 of each cord 30A and 30B are tied or connected to the bottom attachment 20 so that as the first and second cords 30A and 30B are lifted the bottom rib 12 is first lifted and then the second bottom rib 12 is lifted and so on until all of the ribs 12 and roman panels 33 are lifted as shown in FIGS. 7C and 9 as the cords 30A and 30B are lifted by the rotating member 60. The cords 40A and 40B are wound around the rotating member 60 the cords 40A and 40B freely slide within the flexible sleeves 30a and 30B which gather upon themselves as shown in FIG. 7C.

As shown in FIGS. 7A, 7B, and 7C the roman blind has a head rail cassette 5 having a top wall 5T, front wall or panel 5F and rear wall or panel 5R with an open bottom 5B and a partition wall 5P extending from said front panel 5F and disposed between said top panel 5T and said open bottom 5B to define a first chamber 7 having a rotatable member 60 therein, said front panel 5F and partition wall 5P blocking access to said cords 40A and 40B.

The roman blind can also have head rail covering 4C.

FIGS. 15A, 15B show other embodiments of the invention. In particular the attachments 20 show an attachment base 21 which is adapted to sliding received by second channel 11 as previously described. The loop or “D-shaped Loop 20a is in line or generally in the same plane as the base 21. The base 21 extends slightly outwardly from the channel 11. The base 21 includes extensions 21e that are received by expansions or grooves 21g in the channel 11 as shown.

1. A window covering comprising:
a) a fabric having a top and bottom for covering a window;
b) a plurality of horizontally spaced members attached to said fabric, between said top and bottom;
c) at least one attachment secured to each said spaced member;
d) a flexible sleeve attached to each said attachment of said plurality of horizontally spaced members between said top and bottom of said fabric;
e) and a cord extending inside said flexible sleeve from said bottom to said top for lifting said fabric from a closed position covering said window to an open position revealing said window.

2. The window covering as claimed in claim 1 wherein said flexible sleeve includes a grommet adjacent said top attached to said fabric and including an opening in said flexible sleeve for said cord to extend through and into said grommet.

3. The window covering as claimed in claim 1 wherein said top of said fabric depends from a head rail.

4. The window covering as claimed in claim 3 wherein said head rail includes a rotating member attached to said cord that extends through said grommet so as to lift said fabric to said open position when said rotating member is rotated in a first direction and to close said window in said closed position when said rotating bar is rotated in a second direction.

5. The window covering as claimed in claim 4 including a wand attached to said head rail to rotate said rotating member in a first and second direction.

6. The window covering as claimed in claim 5 wherein said wand has two intersecting recesses or projections coaxially disposed within a hand pumping sleeve for rotating said rotatable member between a first and second direction and raise and lower said fabric between an open and closed position when said hand pumping sleeve is moved between a first hand pumping position and a second hand pumping position.

7. The window covering as claimed in claim 6 wherein said extension comprises a shaft having one end attached to said wand and another end of said shaft includes a shaft connection to said head rail.

8. The window covering as claimed in claim 1 wherein said horizontally spaced members comprise ribs that include a first channel extending along the length of said ribs to receive a horizontal portion of said fabric.

9. The window covering as claimed in claim 8 wherein said first channel is “C”-shaped in cross section” and including a rod that extends through said first channel to trap said horizontal portion of said fabric between said rod and said first channel.

10. The window covering as claimed in claim 9 wherein said attachment comprises a “D-shaped” loop, and said ribs include a second channel extending along the length of said rib for slidingly receiving said “D-shaped loops, and said flexible sleeve extends within the space formed by said “D-shaped loops” and are attached to said “D-shaped loops by tie clips.

11. The window covering as claimed in claim 10 wherein said covering is a Roman blind.

12. A Roman blind for a window comprising:
a) a head rail having a rotatable member therein;
b) fabric having a top and bottom for covering a window; said fabric depending from said head rail for covering said window;
c) a plurality of horizontally spaced ribs extending across said fabric, said plurality of horizontally spaced ribs including a first recess for receiving and attaching a horizontal portion of said fabric to said plurality of said horizontally spaced ribs, between said top and bottom of said fabric;
d) a first and second spaced loops secured to each said plurality of horizontally spaced ribs;
e) first and second spaced flexible sleeves disposed vertically through said first and second spaced loops respectively;
f) a plurality of attachments extending through each said first and second flexible sleeves for attaching said sleeves to said loops respectively;
g) first and second cords extending inside said first and second flexible sleeves respectively from said bottom to said bottom, wherein a top of each said cord is attached to said rotatable member; and
h) a wand depending from said head rail for rotating said rotatable member in a first direction for winding said spaced first and second cords around said rotatable member and moving said first and second spaced cords within said first and second flexible sleeves respectively so as to move said fabric from a closed position to an open position, and for rotating said rotatable member in a second direction for unwinding said first and second cords from said rotatable member and moving said spaced first and second cords within said first and second flexible sleeves respectively so as to move said fabric from an open position to an closed position.

13. The Roman blind as claimed in claim 12 wherein said plurality of ribs includes a second channel, and said loops include an attachment portion slidingly receivable within said second recess for placement along said rib.

14. The Roman blind as claimed in claim 13 wherein said spaced loops are ‘D-shaped” and include a base and wherein said D-shaped loops are either in line with said base or disposed at an angle to said base.

15. The Roman blind as claimed in claim 14 wherein said attachment comprises a tie clip extending through said flexible sleeve at each said loop.

16. A head rail for a Roman blind having a top, front and rear panel with an open bottom and a partition wall extending from said front panel and disposed between said top panel and said open bottom to define a first chamber having a rotatable member therein, said front panel and partition wall blocking access to said cords.
